(19) United States
(12) Patent Application Publication
(10) Pub. No.: US 2008/0221961 A1
(43) Pub. Date: Sep. 11, 2008

(54) ONLINE COLLABORATIVE GOAL MARKETPLACE

(75) Inventor: David Carrington JAMES, Arlington, VA (US)

Correspondence Address: PILLSBURY WINTHROP SHAW PITTMAN, LLP, P.O. BOX 10500, MCLEAN, VA, 22102, US

(73) Assignee: Collective Insight LLC, Arlington, VA (US)

(21) Appl. No.: 12/044,389

(22) Filed: Mar. 7, 2008

Related U.S. Application Data
(60) Provisional application No. 60/906,088, filed on Mar. 9, 2007.

(51) Int. Cl. G06Q 10/00; G06F 17/30

(52) U.S. Cl. 705/8; 705/7; 705/1

(57) ABSTRACT

A computer-implemented, online collaborative goal marketplace is provided. The marketplace may include a server programmed with the following modules: a goal creation module, a contribution module, and/or a solution proposal module. The goal creation module may be configured to enable participants to create and publish goals. The contribution module may be configured to receive from contributors and manage contributions of resources to help achieve the goal. The solution proposal module may be configured to receive from solution providers and manage solution proposals, to help accomplish aspects of the goal.

### CROSS-REFERENCE TO RELATED APPLICATION

This application claims priority to U.S. Provisional Patent Application Ser. No. 60/906,088, filed Mar. 9, 2007, which is hereby incorporated by reference herein in its entirety.

### FIELD OF THE INVENTION

The invention relates to an online collaborative goal marketplace.

### BACKGROUND OF THE INVENTION

Various entities seek funding for achieving goals and other projects. For example, non-profits (and other entities) often engage in fund raising drives to help provide resources to accomplish specific tasks. This process is often time consuming and difficult logistically. Often donations are made to a specific organization instead of a specific goal. The donations made to an organization may not be returned to donors when the objectives claimed by the organization are not accomplished. Various other problems and drawbacks exist for entities trying to rely on the resources of others to accomplish various goals.

### SUMMARY OF THE INVENTION

One aspect of the invention relates to a networked system (including, e.g., a website) for implementing a goal marketplace. As used herein, a goal may include a description of something that one or more participants (e.g., an individual, entity, or a group of individuals and/or entities) want to accomplish, through a collaborative effort. The goal may include various goal parameters, including, for example, a title, a description and/or other goal parameters and various goal settings (described below). Any participant who creates a goal may be referred to as a goal creator. Among other things, the system provides an online marketplace where some participants create and contribute to goals and others work and get rewarded for helping achieve a goal.

The system may include mechanisms for facilitating one or more of the following functions: creating, managing and publishing a goal; receiving and managing offers of contribution of resources (e.g., from one or more participants) to help achieve the goal; receiving solution proposals to help achieve the goal; selecting the proposals that will be accepted to help achieve the goal; verifying the selected solution proposals are completed and/or rewarding those who contribute to the solution. The marketplace may include various participants, including one or more of the following: goal creators, contributors, solution providers, verifiers, and/or other participants.

According to one embodiment, the system may include various modules, including one or more of the following: a goal creation module, a contribution module, a solution proposal module, a proposal selection module, a verification module, a search module, a resource allocation module, a payment module and/or other modules.

The goal creation module may be configured to enable participants to create, edit, publish and manage one or more goals. This may include the participant specifying to the system (e.g., via a graphical user interface) various goal parameters, goal settings and/or other goal-related information. If desired, participants other than the initial goal creator may be given an opportunity to comment on the goal, edit the goal or otherwise interact with the goal for some period of time. At some point (e.g., based on a goal setting) the goal will be published.

The contribution module may be configured to receive offers of contributions of resources that may be helpful to enable tasks to be implemented to fully or partially achieve a published goal. The contributions may include various resources such as money, services, facilities and/or other resources. Any participant, who offers contributions of resources for the goal, may be referred to as a contributor. Depending on the goal (e.g., depending on goal settings) at least some contributors may be permitted to provide input into how some or all of the resources contributed for the goal may be allocated, which solution proposals may be selected, and/or other goal-related input.

The solution proposal module may be configured to receive solution proposals to help achieve the goal. The solution proposal may include solution proposal parameters, e.g., a description of tasks to be performed to help accomplish the goal, the resources requested to implement the proposal, the timeline for performing the tasks and/or other solution proposal parameters. One or more participants may offer a full or partial solution to help achieve the goal. These participants may be referred to as solution providers.

The proposal selection module may be configured to enable one or more participants (e.g., one or more goal creators, one or more contributors and/or other designated participants) to select one or more of the received solution proposals. The proposal selection module may include tools for facilitating solution proposal evaluation and selection. The proposal selection module may include a mechanism for publishing, via the system (e.g., via email, posting on a website and/or other mechanism) the selected proposal(s).

The verification module may be configured to enable one or more participants (e.g., one or more designated verifiers) to assist in verifying whether one or more selected solution providers have completed their solution tasks. The verification module may include a mechanism for publishing, via the system (e.g., via email, posting on a website and/or other mechanism) verification (or not) of the selected proposal(s).

The resource allocation module may be configured to facilitate allocation of resources (e.g. payment and/or other resources), which may occur upon verification of the completion of a task, a solution or otherwise. This may be used to reward the solution provider(s) and/or the verifier(s). In some cases, some resources may be allocated before, during and/or after completion of one or more tasks associated with a selected proposal.

The search module may be configured to facilitate the ability to enable visitors and/or current and/or past participants to search for current or past goals, participants, solution proposals and/or other goal-related information. The search module may provide the ability to enable some or all of these participants to identify related goals. The search module may provide the ability to enable some or all of these participants to identify the solution providers and/or the contributors of other related current or past goals. This may be useful, for example, to help identify contributors, resources, solution providers, solution proposals, and/or other relevant information of related current or past goals. This may be useful in many cases, e.g., where different goals are related and share some common characteristics.

The payment module may be configured to enable an operator of the marketplace to automatically collect a fee, based on published goals, the value of contributed resources, and/or rewards to selected solution providers.

The networked system may also include various databases, including one or more of the following: a goals database, a creator profiles database, a contributor profiles database, a solution provider database, a proposal database, and/or other databases.

The goal database may be configured to store goal-related information, including one or more of the following: goal title, goal description, goal parameters, goal settings, goal transaction history (e.g., transactions related to the goal, the status of the goal, the stage in the goal process, participants activities related to the goal, resourced allocated and/or other goal transactions), proposed goal solutions, entities associated with the goal, and/or other goal-related information.

The creator profiles database may be configured to store goal creator-related information, including one or more of the following: goal creator profiles, other goals the goal creator is associated with, other roles the goal creator has played in the goal marketplace, and/or other goal creator-related information.

The contributor profiles database may be configured to store contributor-related information, including one or more of the following: contributor profiles, other goals the contributor is associated with, other roles the contributor has played in the goal marketplace, and/or other contributor-related information.

The solution provider profiles database may be configured to store solution provider information, including one or more of the following: solution provider profiles, other goals the solution provider is associated with, other roles the solution provider has played in the goal marketplace, ratings associated with the solution provider, and/or other solution provider information.

The proposal database may be configured to store proposal information, including one or more of the following: solution proposals, solution provider information associated with the solution proposal, solution proposal status and history, and/or other proposal information.

The networked system (e.g., goal marketplace website) may be accessible via a client terminal running a browser. Other access mechanism may be used.

Another aspect of the invention relates to a method of collaboratively creating, managing and achieving goals through an online goal marketplace. The method may include various processes, including one or more of the following: creating a goal (e.g., by one or more goal creators) during a goal creation phase; publishing the goal; receiving one or more offers of contributions of resources for the published goal (e.g., from one or more contributors); receiving one or more solution proposals to help achieve the goal (e.g., from one or more solution providers); designating and/or rewarding one or more verifiers; evaluating and selecting one or more winning solution proposals; rewarding the selected solution provider(s) upon successful completion of the project, and/or other processes.

During the goal creation phase, a goal may be created and published. This may include a participant creating a goal by specifying a goal title, a goal description, goal parameters and/or one goal settings and/or other goal related information. One or more participants may be involved in creating a goal. For example, once a goal is created, authorized participants may be able to further refine the goal, may provide comments about the goal, and/or may provide input on the goal. After the goal is published, the goal may move from creation phase to a contribution phase.

During the contribution phase, one or more offers of contributions of resources for the goal may be received by the system. At some point, the system may be configured to stop accepting any further offers of contributions (e.g., as determined by goal settings and/or goal parameters). This may end the contribution phase. A solution proposal phase may then begin. In some cases, the contribution phase and solution proposal phase may at least partially overlap.

During the solution proposal phase, one or more solution proposals to help achieve the goal are received by the system. At some point, the system may be configured to stop accepting any further solution proposals (e.g., as determined by goal settings and/or goal parameters). This may end the solution proposal phase. A proposal selection phase may then begin.

During the proposal selection phase, one or more solution proposals received by the system may be evaluated and selected. Once one or more winning solution proposals are selected and may be published via the system. This may end the solution proposal selection phase. A verification phase may then begin.

During the verification phase, one or more designated verifiers may verify the completion of the tasks and other activities specified in the selected solution proposals. Verifiers may be compensated or otherwise rewarded through the system or otherwise. Verification (or lack thereof) may be published via the system. This may end the verification phase. A resource allocation phase may then begin.

During a resource allocation phase, one or more solution providers may be allocated resources. If desired, this may be done after verification that the solution provider has completed the tasks and other activities specified in the selected solution proposals. Resources may be allocated before, during and/or after completion of a solution or a portion thereof. Resource allocation may be tracked via the system.

During a payment phase, a fee based on published goals, the value of contributed resources, and/or rewards to selected solution providers may be collected by the system.

It is contemplated that the method may include one or more of the aforementioned phases, but that not all of the phases may be necessary in some cases. While the order of the phases may be followed as above, it is also contemplated that the order of one or more of the phases may be changed in some cases (e.g., solution proposals may be received before contributions are received, among others). Also some of all of the phases may overlap in such a way that one phase may begin, before the previous phase(s) end.

These and other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates a system for implementing a goal marketplace;

FIG. 2 is a schematic view of a graphical user interface for creating a goal according to one preferred embodiment of the present invention;

FIG. 3 is a schematic view of a graphical user interface for creating a goal according to one preferred embodiment of the present invention;

FIG. 4 is a schematic view of a graphical user interface for creating a goal according to one preferred embodiment of the present invention;

FIG. 5 is a schematic view of a graphical user interface for creating a goal according to one preferred embodiment of the present invention;

FIG. 6 is a schematic view of a graphical user interface for accepting offers of contributions of resources according to one preferred embodiment of the present invention;

FIG. 7 is a schematic view of a graphical user interface for accepting solution proposals according to one preferred embodiment of the present invention;

FIG. 8 is a schematic view of a graphical user interface for selecting solution proposals according to one preferred embodiment of the present invention;

FIG. 9 is a schematic view of a graphical user interface for verifying tasks specified in winning solution proposals according to one preferred embodiment of the present invention; and

FIG. 10 provides a general overview of a method of collaboratively creating, managing and achieving goals through an online goal marketplace.

### DETAILED DESCRIPTION

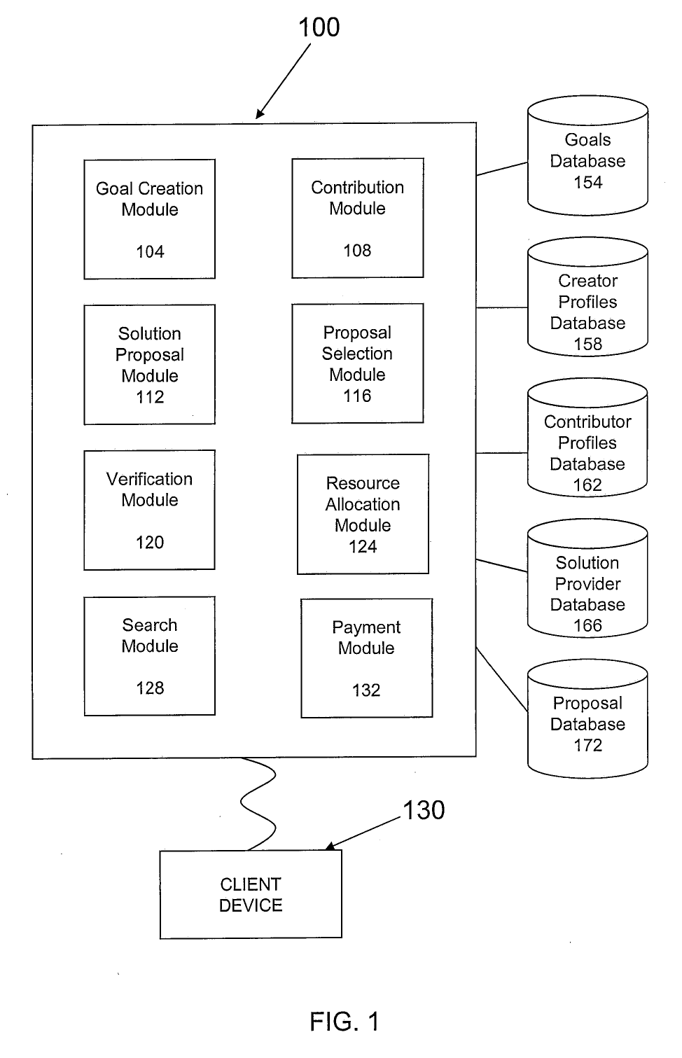

According to an embodiment of the invention illustrated in FIG. 1, a system 100 is provided for implementing a goal marketplace. As used herein, a goal may include a description of something that a participant (e.g., an individual or a group) wants to accomplish, through a collaborative effort. Among other things, the system provides an online marketplace where some participants create and contribute to goals and others work and get rewarded for helping achieve a goal.

The system 100 may include mechanisms for facilitating one or more of the following functions: creating, managing and publishing a goal; receiving and managing offers of contribution of resources (e.g., from one or more participants) to help achieve the goal; receiving solution proposals to help achieve the goal; selecting the proposals that will be accepted to help achieve the goal; verifying the selected solution proposals are completed and/or rewarding those who contribute to the solution.

The marketplace may include various participants, including one or more of the following: goal creators, contributors, solution providers, verifiers, and/or other participants. In addition, any visitors may visit the goal marketplace without actively participating in creating, managing and achieving goals. In one embodiment, the participants of the goal marketplace may not be mutually exclusive. For example, a goal creator may also provide offers of contributions of resources to help achieve a goal.

An operator of the marketplace may be an individual, an entity, or a group of individuals and/or entities, who operates the marketplace. In one embodiment, an operator may be a participant of the goal marketplace.

The system 100 may include various modules, including one or more of the following: a goal creation module 104, a contribution module 108, a solution proposal module 112, a proposal selection module 116, a verification module 120, a resource allocation module 124, a search module 128, a payment module 132 and/or other modules. The modules may include various software and/or hardware modules to enable the functionality and process described herein. The software modules may be used to program a server or other computer device to enable the functionality described herein. The networked system 100 may also include various databases, including one or more of the following: a goals database 154, a creator profiles database 158, a contributor profiles database 162, a solution provider database 166, a proposal database 172, and/or other databases. The system 100 may be accessible via one or more client devices 130, which may be used by one or more participants to interact with the system and perform various goal processes, as described herein.

The goal creation module 104 may be configured to enable participants to create, edit, publish and manage one or more goals. Any participant who creates a goal may be referred to as a goal creator.

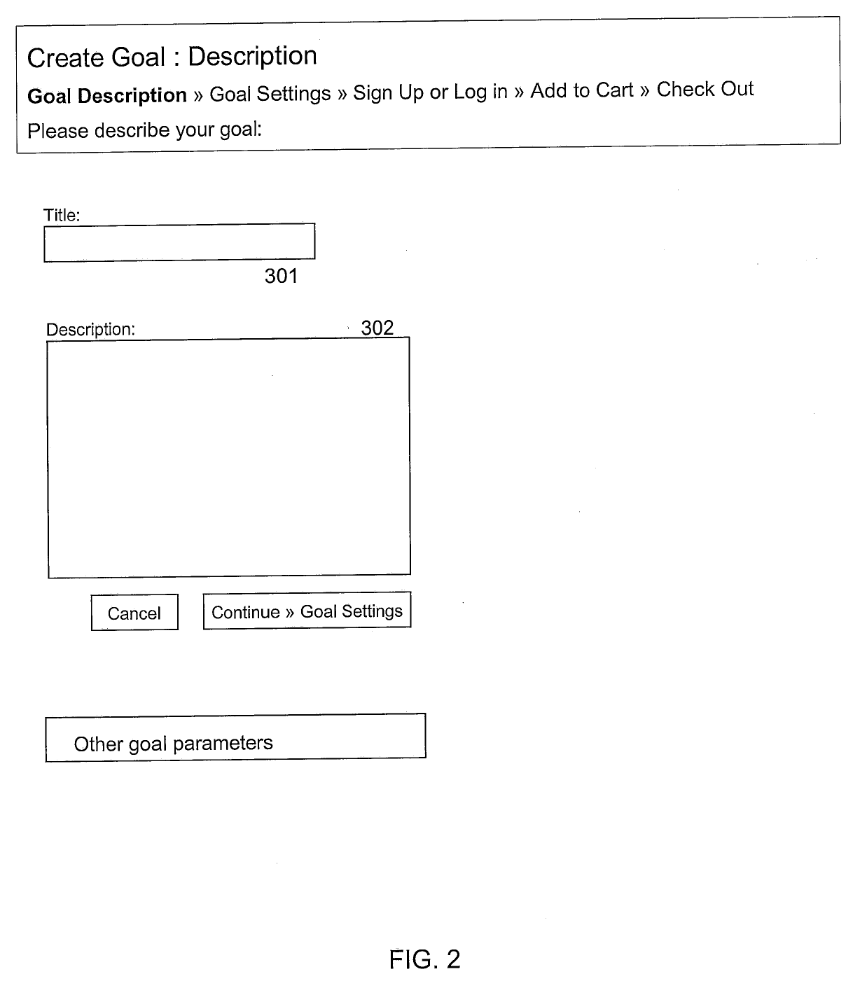

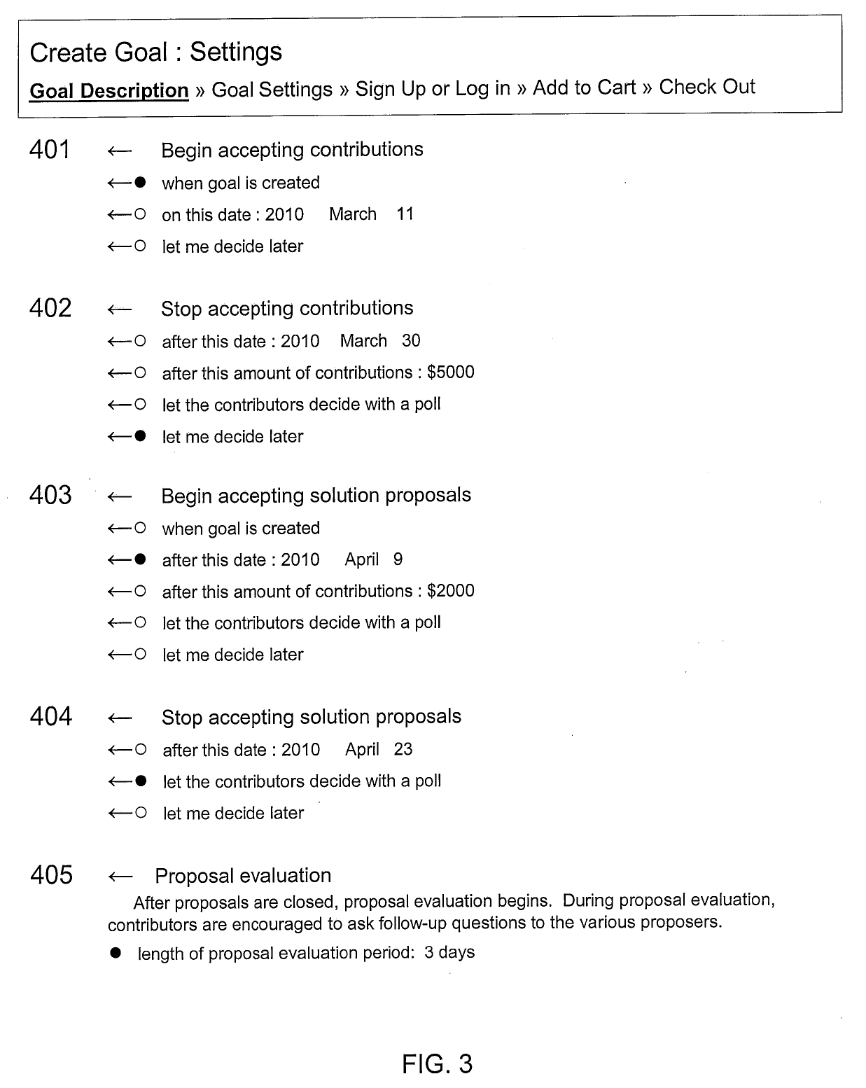

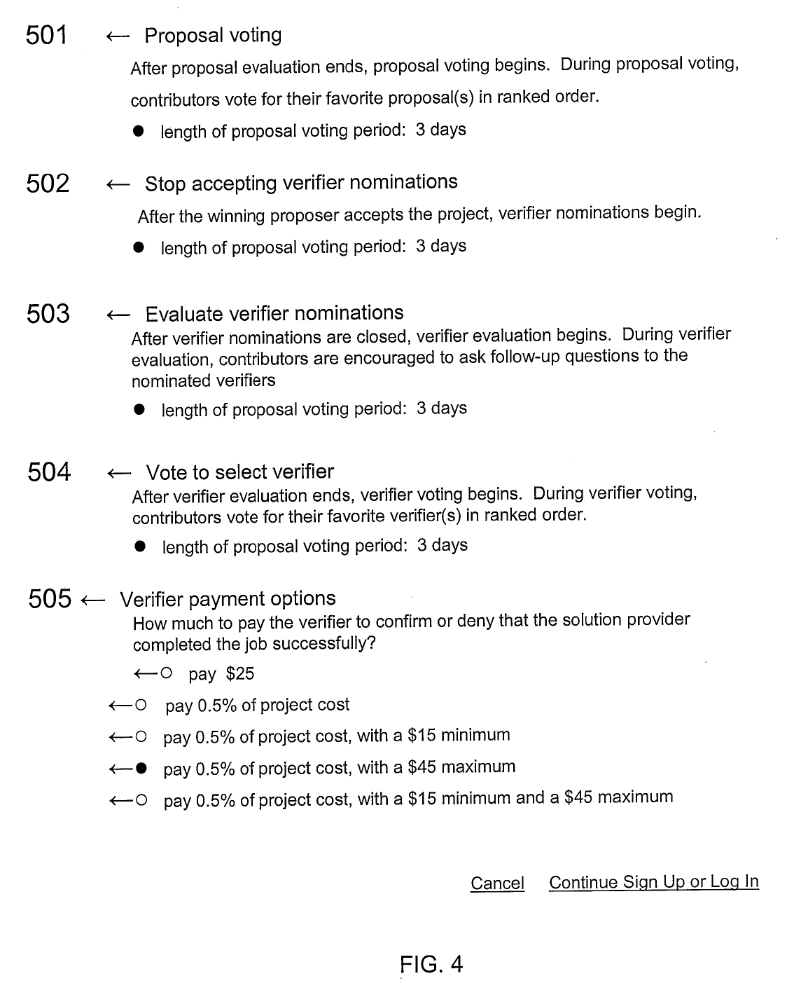

As shown, for example, in FIGS. 2-4, the goal may include a title 301, a description 302, goal settings and/or other goal parameters 401-505. In one embodiment, the title 301 and the description 302 fields may accept free text and/or have some structured fields. In other embodiments, a goal may comprise additional goal-related information in various formats, including but not limited to hypertext, structured data, images, video, and audio. A goal may be broad or specific as determined by one or more goal creators. For example, the goal may or may not specify exactly how the offers of contributions of resources are to be spent. A goal may be privately or publicly available. In one embodiment, the system may be configured to enable one or more participants of the goal marketplace to create a private goal, which may have restricted access to one or more participants.

In one embodiment, the goal creation module 104 may provide guidelines, examples and ideas on how to create a goal. The guidelines for creating a goal may include one or more of the following: whom the goal is related to, how the goal is beneficial to one or more entities (e.g., person, community, team or organization), where the goal may take place (e.g., neighborhood, city or state) and/or other guidelines.

The goal parameters and/or settings may include one or more of the following: contribution-accepting triggers 401 and 402, proposal-accepting triggers 403 and 404, proposal evaluation period 405, proposal voting period 501, verifier nomination period 502, verifier evaluation period 503, verifier voting period 504, verifier rewards 505, and/or other goal parameters.

The goal creation module 104 may be configured to enable one or more goal creators to specify the contribution-accepting triggers 401 (e.g., the conditions under which a goal may start accepting the offers of contributions of resources) and contribution-accepting triggers 402 (e.g., the conditions under which a goal may stop accepting the offers of contributions of resources). The contribution-accepting triggers 401 and 402 may include manually activated triggers and/or automatically activated triggers. In one embodiment, the automatically activated triggers for the contribution-accepting triggers 401 may include one or more of the following: occurrences of events immediately after the goal is created; occurrences of events such as passage of a certain specified amount of time (any number of minutes, hours, days, weeks, months, etc.), occurrences of events such as passage of a certain amount of time without any activity with respect to the created goal (inactivity timeouts etc), occurrences of events such as passage of a certain amount of time without any revisions made to the created goal, and/or other automatic triggers. In one embodiment, the manually activated triggers may enable one or more goal creators to specify later the conditions under which the goal may start accepting the offers of contributions of resources.

In one embodiment, the automatically activated triggers for the contribution-accepting triggers 402 may include one or more of the following: occurrences of events such as passage of a certain specified amount of time (any number of minutes, hours, days, weeks, months, etc.), occurrences of events such as passage of a certain amount of time without any activity with respect to the created goal (inactivity timeouts etc), the offers of contributions of the resources reach a specified amount of resources, occurrences of events based on the result of a poll by contributors, and/or other automatic triggers. In one embodiment, the manually activated triggers may enable one or more goal creators to specify later the conditions under which the goal may stop accepting the offers of contributions of resources.

The goal creation module 104 may be configured to enable one or more goal creators to specify the proposal-accepting triggers 403 (e.g., the conditions under which a goal may start accepting the solution proposals) and proposal-accepting triggers 404 (e.g., the conditions under which a goal may stop accepting the solution proposals). The proposal-accepting triggers 403 and 404 may include manually activated triggers and/or automatically activated triggers. In one embodiment, the automatically activated triggers for the proposal-accepting triggers 403 may include one or more of the following: occurrences of events immediately after the goal is created; occurrences of events such as passage of a certain specified amount of time (any number of minutes, hours, days, weeks, months, etc.), occurrences of events such as passage of a certain amount of time without any activity with respect to the created goal (inactivity timeouts etc), occurrences of events such as passage of a certain amount of time without any revisions made to the created goal, occurrences of events after the offers of contributions of the resources reaches a specified amount of resources, occurrences of events based on the result of a poll by contributors, and/or other automatic triggers. In one embodiment, the manually activated triggers may enable one or more goal creators to specify later the conditions under which the goal may start accepting the solution proposals.

In one embodiment, the automatically activated triggers for the proposal-accepting triggers 404 may include one or more of the following: occurrences of events such as passage of a certain specified amount of time (any number of minutes, hours, days, weeks, months, etc.), occurrences of events such as passage of a certain amount of time without any activity with respect to the created goal (inactivity timeouts etc), occurrences of events such as passage of a certain amount of time without any revisions made to the created goal, occurrences of events based on the result of a poll by contributors, and/or other automatic triggers. In one embodiment, the manually activated triggers enable one or more goal creators to specify later the conditions under which the goal may stop accepting the solution proposals.

The goal creation module 104 may be configured to enable one or more goal creators to specify proposal evaluation period 405. The proposal evaluation period 405 may include a period of time (any number of minutes, hours, days, weeks, months, etc.) allocated for evaluating a proposal and/or other evaluation criteria.

The goal creation module 104 may be configured to enable one or more goal creators to specify proposal voting period 501. The proposal voting period 501 may include a period of time (any number of minutes, hours, days, weeks, months, etc.) allocated for voting one or more proposals and/or other proposal evaluation criteria.

The goal creation module 104 may be configured to enable one or more goal creators to specify verifier nomination period 502. The verifier nomination period 502 may include a period of time (any number of minutes, hours, days, weeks, months, etc.) allocated for nominating one or more verifiers and/or other verifier criteria.

The goal creation module 104 may be configured to enable one or more goal creators to specify verifier evaluation period 503. The verifier evaluation period 503 may include a period of time (any number of minutes, hours, days, weeks, months, etc.) allocated for evaluating one or more verifiers.

The goal creation module 104 may be configured to enable one or more goal creators to specify verifier voting period 504. The verifier voting period 504 may include a period of time (any number of minutes, hours, days, weeks, months, etc.) allocated for voting one or more verifiers and/or other verifier voting criteria.

The goal creation module 104 may be configured to enable one or more goal creators to specify verifier rewards 505. The verifier rewards 505 may include various rewards, including one or more of the following: a fixed amount, a percentage value of the project cost, a percentage value of the project cost with a minimum fixed amount, a percentage value of the project cost with a maximum fixed amount, a percentage value of the project cost with a minimum fixed amount and a maximum fixed amount, any combination of these rewards, and/or other rewards.

In one embodiment, the goal creation module 104 may be configured to enable one or more goal creators to specify solution provider rewards. The solution provider rewards may include various rewards, including one or more of the following: a fixed amount, a percentage value of the project cost, a percentage value of the project cost with a minimum fixed amount, a percentage value of the project cost with a maximum fixed amount, a percentage value of the project cost with a minimum fixed amount and a maximum fixed amount, any combination of these rewards, and/or other rewards.

Referring back to FIG. 1, the contribution module 108 may be configured to receive offers of contributions of resources that may be helpful to enable tasks to be implemented to fully or partially achieve the goal. The contributions may include various resources such as money, services, facilities and/or other resources. Any participant, who offers contributions of resources for the goal, may be referred to as a contributor. The contributors in the goal marketplace may remain anonymous or may use a pseudonym instead of their names. In one embodiment, the contributors in the goal marketplace may elect whether to receive any correspondence regarding related goals. The contributor may not only contribute resources but also provide input into how the resources contributed for the goal may be allocated, which solution proposals may be selected, and/or other goal-related input.

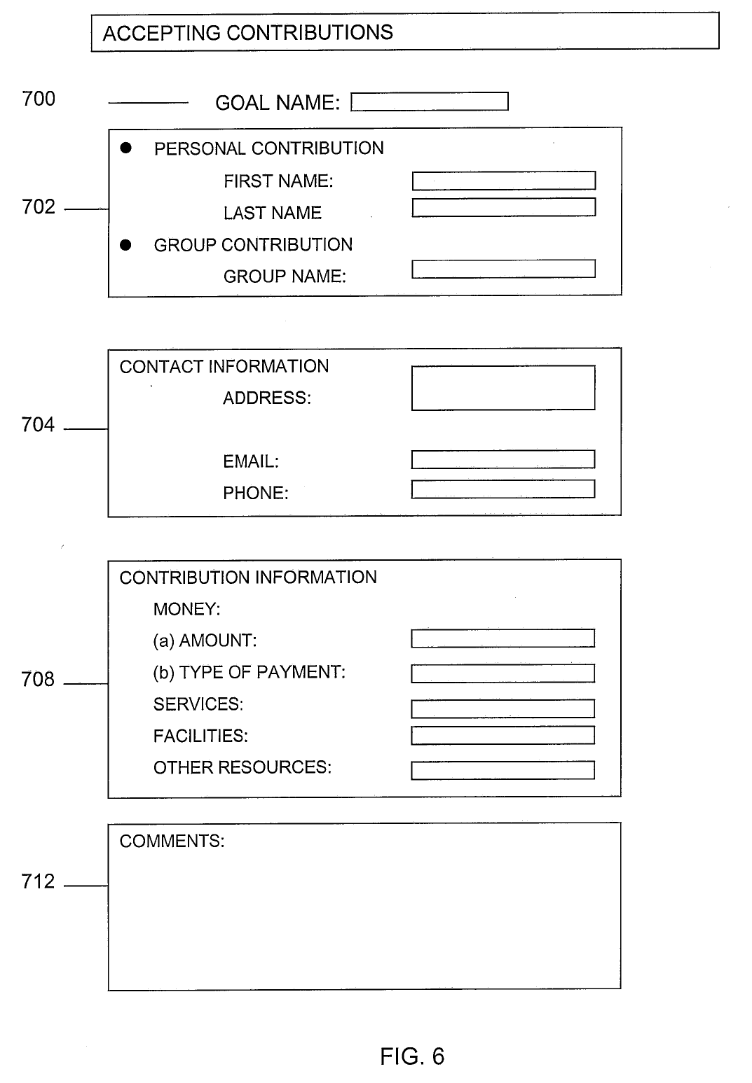

As shown in FIG. 6, the contribution module 108 may be configured to enable one or more contributors to provide various contribution-related information, including one or more of the following: name 700 of the goal to which one or more contributors may provide the offers of contributions of resources; name 702 of the contributor (e.g., the first name or the last name for a personal contributor, or group name for a group contribution), contact information 704 of the contributor (e.g., address, email ID, phone number and/or other contact information), contribution information 708, comments 712 from the contributor, and/or other contribution-related information. The contribution information 708 may include various resources such as money, services, facilities, and/or other resources. The payment of money may include but not limited to payment amount and payment type (e.g., cash, credit, check, and/or other types of payments). The services may include but not limited to volunteering time for performing goal processes. The facilities may include providing accommodations and/or other facilities to help achieve the goal.

In one embodiment, the system 100 may collect a payment from one or more contributors to provide offers of contributions of resources to achieve a goal. The payment may include but not limited to a fee, and/or other services. In other embodiments, the contribution module 108 may waive payment for providing offers of contributions of resources to help achieve a goal based on other conditions, such as not-for-profit status, or promotional programs.

Referring back to FIG. 1, the solution proposal module 112 may be configured to receive solution proposals to help achieve the goal. The solution proposal may include a description of tasks to be performed to help accomplish the goal, the resources requested to implement the proposal, the timeline for performing the tasks and/or other solution proposal parameters. In one embodiment, the solution proposal may include information whether the solution in the solution proposal is tax-deductible, impact-evaluation of the solution in the solution proposal, and/or number of people taking advantage of the solution in the solution proposal on a daily, weekly, monthly, or yearly basis. One or more participants may offer a full or partial solution to help achieve the goal. These participants may be referred to as solution providers.

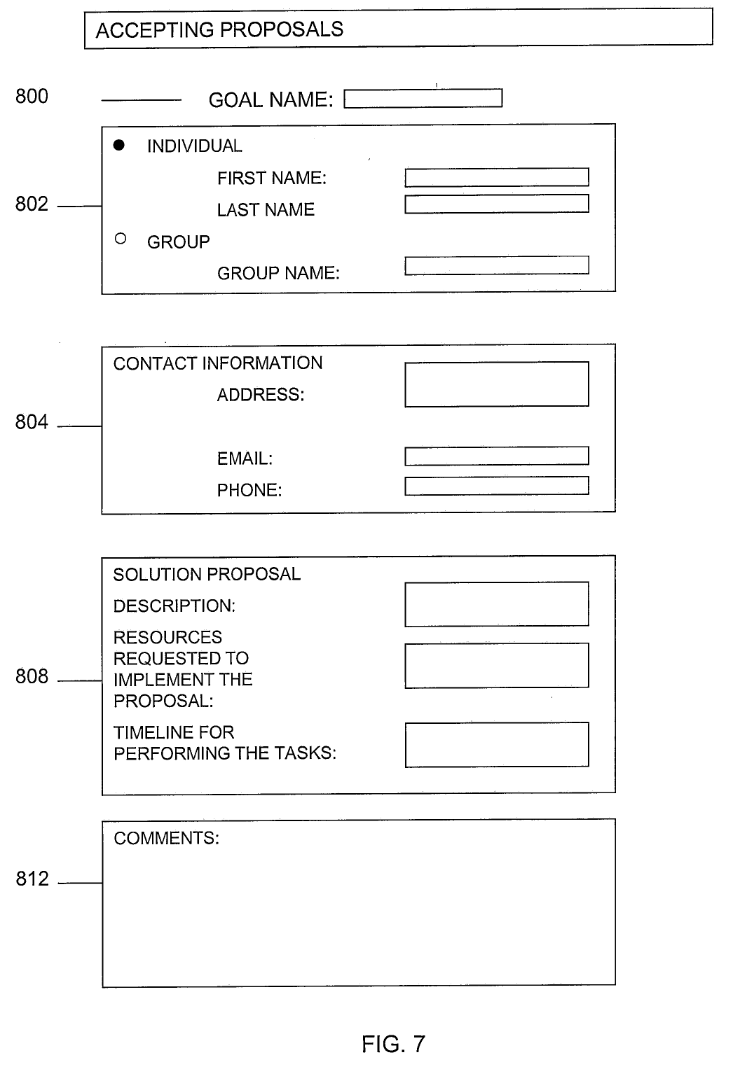

As shown in FIG. 7, the solution proposal module 112 may be configured to enable one or more solution providers to provide various proposal information, including one or more of the following: name 800 of the goal to which one or more solution providers may provide the solution proposals; name 802 of the solution provider (e.g., the first name or the last name for a sole solution provider, or group name for a solution provider group), contact information 804 of the solution provider (e.g., address, email ID, phone number and/or other contact information), proposal information 808, comments 812 from the solution provider, and/or other proposal-related information. The proposal information 808 may include description of tasks to be performed to help accomplish the goal, the resources requested to implement the proposal, the timeline for performing the tasks and/or other solution proposal parameters.

Referring back to FIG. 1, the proposal selection module 116 may be configured to enable one or more goal creators, one or more contributors and/or other designated participants to select one or more of the received solution proposals. The proposal selection module may include tools for facilitating solution proposal evaluation and selection.

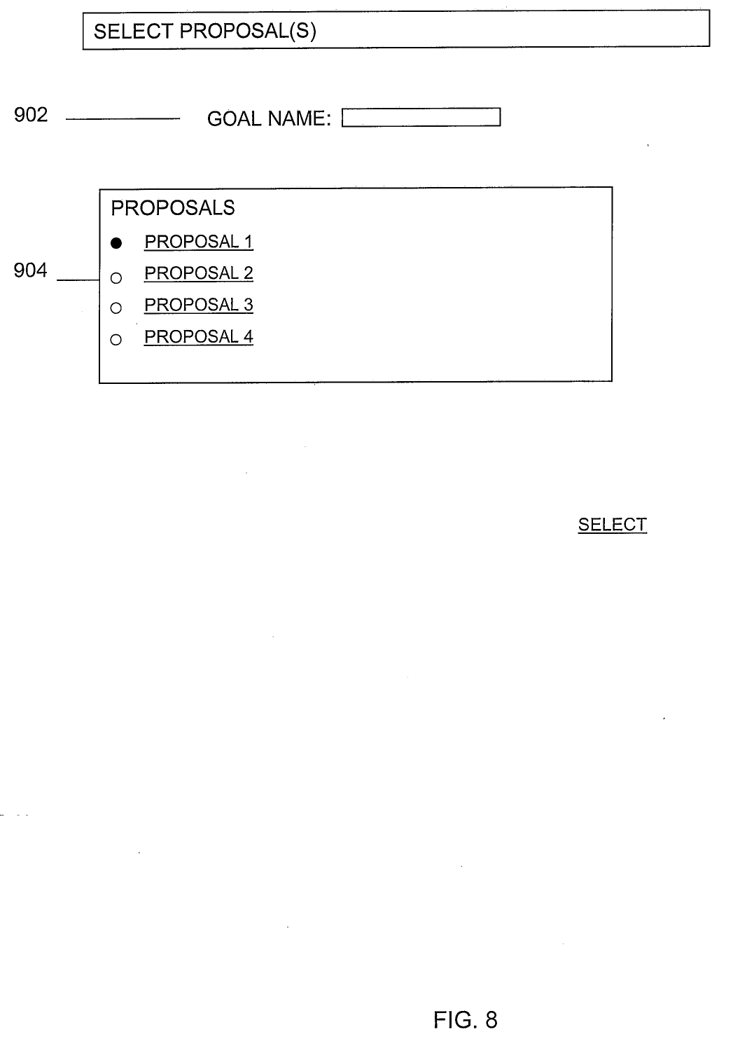

As shown in FIG. 8, the proposal selection module 116 may be configured to enable one or more participants of the goal marketplace to select one or more of the received solution proposals 904 for a goal 902.

Referring back to FIG. 1, the verification module 120 may be configured to assist in verifying whether one or more selected solution providers have completed their solution tasks. A participant who decides whether the solution provider completed the task in a satisfactory manner is referred to as verifiers. In one embodiment, a goal may have one or more verifiers to verify whether one or more selected solution providers have completed their solution tasks.

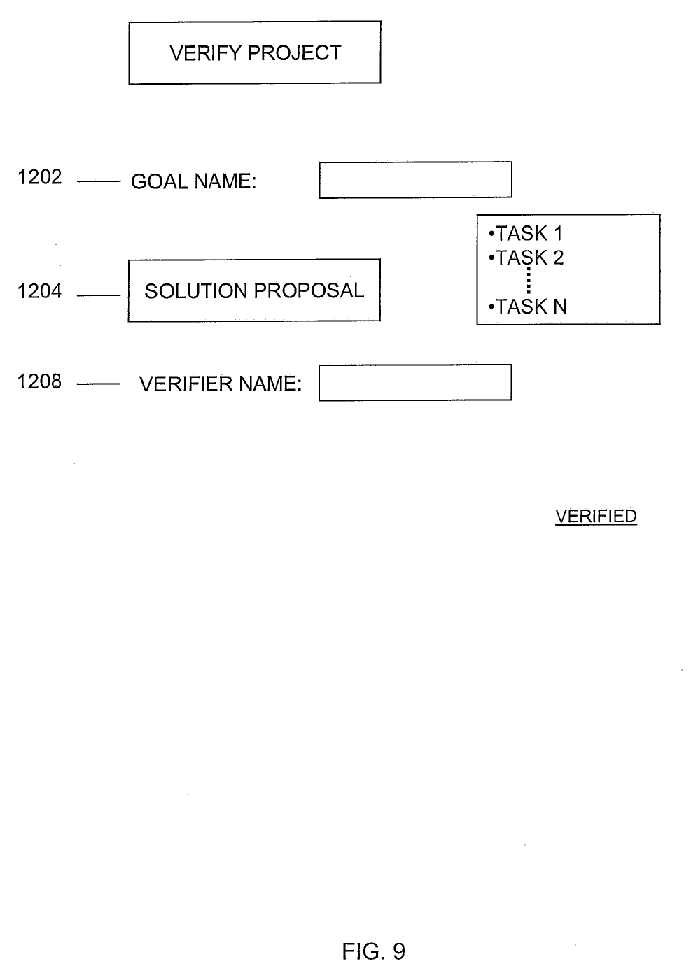

As shown in the FIG. 9, the verification module 120 may be configured to enable a verifier 1208 to verify whether one or more selected solution proposals 1204 for a goal 1202 have been completed successfully.

Referring back to FIG. 1, the resource allocation module 124 may be configured to facilitate allocation of resources (e.g. payment), which may occur upon verification of the completion of a task, a solution or otherwise. This may be used to reward the solution provider(s) and/or the verifier(s).

The search module 128 may be configured to facilitate the ability to enable visitors and/or current and/or past participants to search for current or past goals, and/or solution proposals, among other goal-related information. The search module may provide the ability to enable some or all of these participants to identify related goals. The search module may provide the ability to enable some or all of these participants to identify the solution providers and/or the contributors of other related current or past goals. This may be useful, for example, to help identify contributors, resources, solution providers, solution proposals, and/or other relevant information of related current or past goals.

The current goals may include any goals in the goal marketplace that are active. The current contributors may include any participants in the goal marketplace, who provide offers of contributions of resources to help achieve the current goals. The current solution providers may include any participants in the goal marketplace, who may offer full or partial solutions to help achieve the current goals. The current solution proposals may include descriptions of tasks to be performed to help accomplish the current goals, resources requested to implement the proposals, timelines for performing the tasks, and/or other solution proposal parameters.

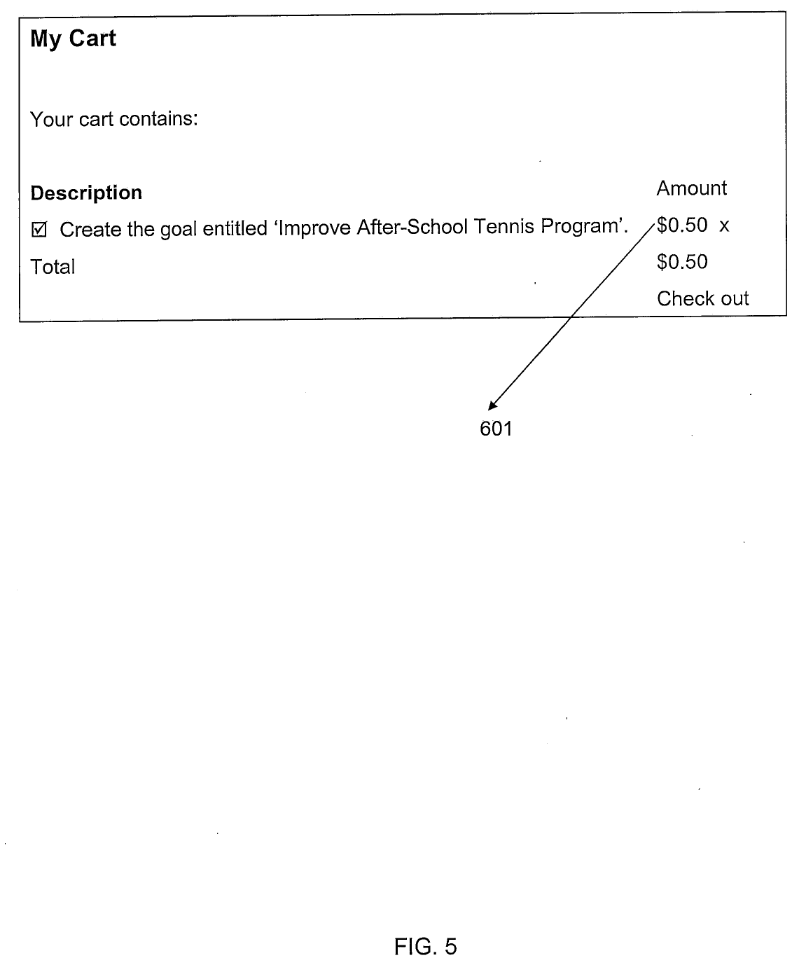

The payment module 132 may be configured to enable an operator of the marketplace to automatically collect a fee based on published goals. In one embodiment, as shown for example in FIG. 5, the system 100 may collect a payment or fee 601 from one or more goal creators to publish a goal. The payment may include but is not limited to a fee, and/or other services. In other embodiments, the goal creation module 104 may waive payment for publishing a goal based on other conditions, such as not-for-profit status, or promotional programs. The payment module 132 may be configured to enable an operator of the marketplace to automatically collect a fee based on the value of contributed resources. In one embodiment, this fee may be collected by the system from one or more contributors. The payment module 132 may be configured to enable an operator of the marketplace to automatically collect a fee based on rewards to selected solution providers. In other cases, the system may charge the goal creators a fee based on the resources contributed to the goal and/or charge the solution providers based the value of the resources and/or rewards the solution provider(s) receive. Other business methods may be implemented via the system.

The goal database 154 may be configured to store goal-related information, including one or more of the following: title, description, parameters, settings, transaction history (e.g., the status of the goal, the stage in the goal process), proposed solutions, entities associated with the goal, success of a goal (e.g., whether the goal succeeded), and/or other goal-related information. In one embodiment, a goal may be successful upon completion and verification of the tasks of the solution proposal(s).

The creator profiles database 158 may be configured to store creator-related information, including one or more of the following: goal creator profiles, other goals the goal creator is associated with, other roles the goal creator has played in the goal marketplace, information about one or more networking (e.g., friends or peers) groups the goal creator is associated with, creator involvement rating (e.g. how involved the goal creator is in the goal marketplace, how interactive the goal creator is with other participants of the goal marketplace), and/or other creator-related information. In one embodiment, the creator involvement rating may include rating parameters such as time spent by the creator in the goal marketplace, number of messages sent to other participants in the goal marketplace, and/or other rating parameters.

The contributor profiles database 162 may be configured to store contributor-related information, including one or more of the following: contributor profiles, other goals the contributor is associated with, other roles the contributor has played in the goal marketplace, information about one or more networking (e.g., friends or peers) groups the contributor is associated with, participation rating (e.g., degree to which the contributor participates in different activities such as discussions, proposal selection, or verifier selection in the goal marketplace), and/or other contributor-related information. In one embodiment, the contributor participation rating may include rating parameters such as time spent by the contributor in the goal marketplace, number of messages sent to other participants in the goal marketplace, number of questions the contributor asked solution provider(s), and/or other rating parameters.

The solution provider profiles database 166 may be configured to store solution provider information, including one or more of the following: solution provider profiles, other goals the solution provider is associated with, other roles the solution provider has played in the goal marketplace, ratings associated with the solution provider, information about one or more networking (e.g., friends or peers) groups the solution provider is associated with, qualifications of the solution provider, and/or other solution provider information.

The proposal database 172 may be configured to store proposal information, including one or more of the following: solution proposals, solution provider information associated with the solution proposal, solution proposal status and history, proposal relevance rating (e.g., degree to which the solution proposal is relevant to the associated goal), and/or other proposal information. The proposal relevance rating may include rating parameters such as number of contributor messages directed to a particular proposal, number of times the solution proposal is flagged as inappropriate or off-topic, the final ranking based on the contributor vote on the proposals, and/or other rating parameters.

In one embodiment, the system 100 may also include one or more databases that may be configured to store information related to goal marketplace including one or more of the following: verifier profiles, verifier qualifications, success rates of all goals in the goal marketplace, success rates of the goals created during a specific time period, success rates of the goals that received at least a specific amount of contributions, success rates of goals that received at least a certain number of solution proposals and/or other goal marketplace-related information.

In one embodiment, the system 100 may be configured to rank a goal by number of contributors, by number of contributions of resources, by amount of contributions of resources, and/or by number of solution proposals received. The system 100 may be configured to rank a goal creator by number of goals created, by contributions of resources received for the created goals, and/or by success rate of the created goals. The system 100 may be configured to rank a contributor by number of goals the contributor is contributed to, by total amount of resources contributed to goals, by success rate of the contributor goals, participation of the contributor in proposal selection, and/or participation of the contributor in verifier selection. The system 100 may be configured to rank a solution provider by number of goals the solution provider is proposed to, by number of times the solution provider is nominated as a winning provider, by percentage success rate (e.g. number of times the solution provider is nominated as a winning solution provider divided by number of times the solution provider proposed a solution), and/or by verification rate of the solution providers' projects or tasks (e.g., percentage of projects or tasks were verified as complete). The system 100 may be configured to rank a verifier by number of times the participant is nominated as a verifier, by number of times the participant is selected as a verifier, and/or by verification rate of the verifiers' projects (e.g., percentage of projects or tasks were verified as complete).

In one embodiment, the system 100 may be configured to cluster goals by keyword so that related goals may be easily identified as being similar, and/or by geography so that potential contributors in an area may easily find goals near them. The system 100 maybe configured to cluster goal creators by goal topic (e.g., who tend to create similar goals, so that they may consider joining forces for future goals) and/or by success rate (e.g., highly successful goal creators may want to network with each other). The system 100 may be configured to cluster contributors by goal topic (e.g., who tend to contribute to similar goals) and/or by geography (e.g., who are close to each other and thus may want to work together). The system 100 may be configured to cluster solution proposals by keyword so that related solution proposals be easily identified as being similar and/or by geography so that the system 100 may create a directory of solution providers in particular areas.

In one embodiment, the system 100 may be configured to conduct statistical analysis to look at the correlation between various goal settings and goal outcomes. For example, it may useful to correlate the length of contribution period to the amount of contributions of resources received, the length of proposal period to the number of proposals received, and/or description keywords to achievement of success (e.g., to see which keywords are most correlated to goal success). These statistics may be useful to improve the effectiveness of future goals. For example, understanding these statistics may help goals receive more contribution of resources, receive more solution proposals, and/or to be more successful. These statistics may also help participants of the goal marketplace with various goal marketplace activities, such as focusing energy on goals that are more likely to succeed thus creating more satisfied participants, and/or assisting specific, targeted goals or goal creators during specific times thus helping the participants to be more effective in their goals.

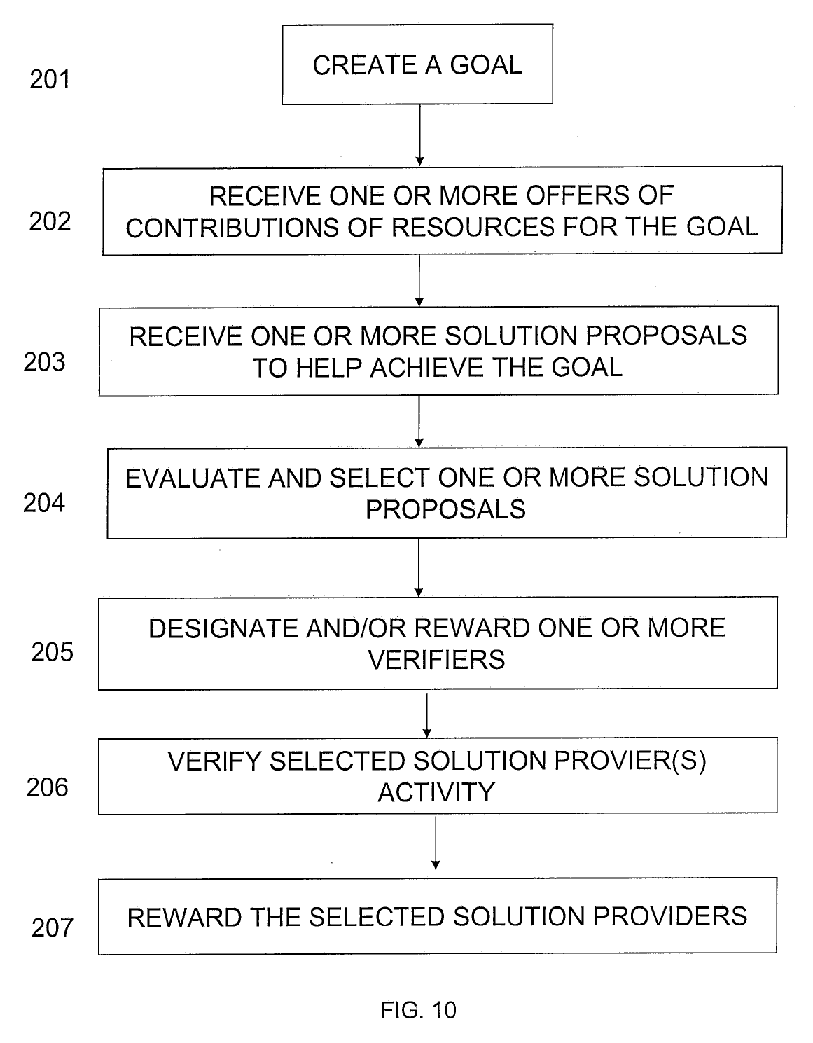

Another aspect of the invention relates to a method of collaboratively creating, managing and achieving goals through an online goal marketplace as shown in FIG. 10. The method 200 may include various processes, including one or more of the following: creating and publishing a goal 201 (e.g., by one or more goal creators) during a goal creation phase; receiving one or more offers of contributions of resources for the published goal 202 (e.g., from one or more contributors); receiving one or more solution proposals to help achieve the goal 203 (e.g., from one or more solution providers); evaluating and selecting one or more winning solution proposals 204; designating and/or rewarding one or more verifiers 205; verifying selected solution providers activity 206; rewarding the selected solution provider(s) upon successful completion of the project 207, and/or other processes.

During the goal creation phase, a goal may be created and published 201. Once a goal is created, authorized participants may be able to further refine the goal, may provide comments about the goal, and/or may provide input to the goal. After the goal is published, the goal may move from creation phase to a contribution phase.

During the contribution phase, one or more offers of contributions of resources for the goal may be received 202. At some point, the system may be configured to stop accepting any further offers of contributions (e.g., as determined by goal settings and/or goal parameters). This may end the contribution phase and begin a solution proposal phase. In one embodiment, one or more goal creators may create a goal and provide offers of contributions of resources to a goal in a single step.

During the solution proposal phase, one or more solution proposals to help achieve the goal are received 203. At some point, the system may be configured to stop accepting any further solution proposals (e.g., as determined by goal settings and/or goal parameters). This may end the solution proposal phase and begin a proposal selection phase.

During the proposal selection phase, one or more solution proposals received by the system may be evaluated and selected 204. During the proposal selection phase, one or more participants of the goal marketplace evaluate the solution proposals and may ask solution provider(s), who submitted one or more solution proposals to the goal, any follow-up questions. The system may be configured to prevent proposal evaluation (e.g., as determined by goal settings and/or goal parameters) at some point.

In one embodiment, during the solution proposal selection phase, one or more participants of the goal marketplace may vote for one or more winning solution proposals. In one embodiment, the system may be configured to prevent proposal voting (e.g., as determined by goal settings and/or goal parameters) at some point. A ballot, a vote-counting algorithm, and/or other selection mechanisms may be used by the system to select the winning solution proposal(s). In one embodiment, the system may notify the solution provider(s) of the winning solution proposal(s). In one embodiment, the solution provider of the winning solution proposal may accept to perform the tasks to help achieve the goal. In one embodiment, if the winning solution provider declines to perform the tasks, then the system may lower the solution provider's status rating and repeat the solution proposal selection process. Once one or more winning solution proposals are selected, the solution proposal selection phase may end and a verification phase may begin.

During the verification phase, one or more verifier nominations received by the system may be evaluated and selected 205. The system is configured to stop accepting verifier nominations (e.g., as determined by goal settings and/or goal parameters) at some point. In one embodiment, one or more participants of the goal marketplace may ask various potential verifiers any follow-up questions, and evaluate the verifier nominations. The system may be configured to prevent verifier evaluation (e.g., as determined by goal settings and/or goal parameters) at some point.

In one embodiment, during the verification phase, one or more participants of the goal marketplace may vote for a winning verifier(s). In one embodiment, the system may be configured to prevent verifier voting (e.g., as determined by goal settings and/or goal parameters) at some point. A ballot or a vote-counting algorithm may be used by the system to select the winning verifier(s). In one embodiment, the participants of the goal marketplace may nominate themselves as verifiers. In one embodiment, the system may notify the winning verifier. In one embodiment, if the winning verifier declines the verification task, then the system may lower the verifier's status rating and repeat the verifier selection process. In one embodiment, one or more designated verifiers may verify the completion of the tasks and other activities specified in the selected solution proposal(s) 206. Once one or more winning verifiers are selected, the verification phase may end and a resource allocation phase may begin.

During the resource allocation phase, one or more solution providers may be allocated with resources 207. If desired, this may be done after verification that the solution provider has completed the tasks and other activities specified in the selected solution proposals. Resources may be allocated before, during and/or after completion of a solution or a portion thereof. In one embodiment, the system may allocate resources to one or more solution providers and one or more verifiers, when one or more verifiers verify and report successful completion of the tasks and other activities specified in the selected solution proposals. In other embodiment, when one or more verifiers verify and report a failure in completion of the tasks and other activities specified in the selected solution proposals, the system may allocate resources to one or more verifiers, lower the solution providers status rating, and repeat the solution proposal evaluation and selection process.

During a payment phase, a fee based on published goals, the value of contributed resources, and/or rewards to selected solution providers may be collected by the system.

It is contemplated that the method may include one or more of the aforementioned phases and is also contemplated that these phases may overlap in such a way that one phase may begin, before the previous phase(s) end. In some cases the order of the phases may differ from that set forth above.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A computer-implemented, online collaborative goal marketplace, comprising:
a server programmed with the following modules:
a goal creation module configured to enable participants to create and publish goals;
a contribution module configured to receive from contributors and manage contributions of resources to help achieve the goal; and
a solution proposal module configured to receive from solution providers and manage solution proposals, to help accomplish aspects of the goal.

2. The online collaborative goal marketplace of claim 1, further comprising a proposal selection module configured to enable evaluation and selection of one or more received solution proposals and notify the solution provider from whom selected proposals were received.

3. The online collaborative goal marketplace of claim 1, further comprising a verification module configured to enable participants to assist in verifying whether one or more selected solution providers have completed their solution tasks.

4. The online collaborative goal marketplace of claim 1, further comprising a resource allocation module configured to facilitate allocation of resources, which may occur upon verification of the completion of a task, a solution or otherwise.

5. The online collaborative goal marketplace of claim 1, further comprising a search module configured to facilitate the ability to enable visitors and/or participants to search for current or past goals, participants, solution proposals and/or other goal-related information.

6. The online collaborative goal marketplace of claim 1, further comprising a goal database configured to store goal-related information.

7. The online collaborative goal marketplace of claim 1, further comprising a creator profiles database configured to store goal creator-related information.

8. The online collaborative goal marketplace of claim 1, further comprising a contributor profiles database configured to store contributor-related information.

9. The online collaborative goal marketplace of claim 1, further comprising a solution provider profiles database configured to store solution provider information.

10. The online collaborative goal marketplace of claim 1, further comprising a proposal database configured to store proposal information.

11. The online collaborative goal marketplace of claim 1, further comprising a payment module configured to enable an operator of the marketplace to automatically collect a fee based on published goals.

12. The online collaborative goal marketplace of claim 1, further comprising a payment module is configured to enable an operator of the marketplace to automatically collect a fee based on the value of contributed resources.

13. The online collaborative goal marketplace of claim 1, further comprising a payment module is configured to enable an operator of the marketplace to automatically collect a fee based on rewards to selected solution providers.

14. The online collaborative goal marketplace of claim 1, wherein the goal includes a title, a description and one or more goal parameters.

15. The online collaborative goal marketplace of claim 1, wherein the resources include one or more of money, facilities, services, and/or other resources.

16. The online collaborative goal marketplace of claim 1, wherein the solution proposals include solution proposal parameters, the resources requested to implement the proposal, the timeline for performing the tasks and/or other solution proposal parameters.

17. The online collaborative goal marketplace of claim 1, wherein the search is configured to enable search of current and past goals.

18. The online collaborative goal marketplace of claim 1, wherein the search is configured to enable search of current and past contributors

19. The online collaborative goal marketplace of claim 1, wherein the search is configured to enable search of current and past solution providers

20. The online collaborative goal marketplace of claim 1, wherein the search is configured to enable search of current and past solution proposals

21. A method of collaboratively creating, managing and achieving goals through an online goal marketplace, comprising:
creating and publishing a goal;
receiving one or more offers of contributions of resources for the published goal to help achieve the goal; and
receiving one or more solution proposals to help accomplish the goal.

22. The method of claim 21, further comprising evaluating and selecting one or more received solution proposals and notifying a solution provider from whom selected proposals were received.

23. The method of claim 21, further comprising verifying whether one or more selected solution providers have completed their solution tasks.

24. The method of claim 21, further comprising facilitating allocation of resources, which may occur upon verification of the completion of a task, a solution or otherwise.

25. The method of claim 21, further comprising searching for current or past goals, participants, solution proposals and/or other goal-related information.

26. The method of claim 21, further comprising storing goal-related information in a goal database.

27. The method of claim 21, further comprising storing goal creator-related information in a creator profiles database.

28. The method of claim 21, further comprising storing contributor-related information in a contributor profiles database.

29. The method of claim 21, further comprising storing solution provider information in a solution provider profiles database.

30. The method of claim 21, further comprising storing proposal information in a proposal database.

31. The method of claim 21, further comprising collecting a fee based on published goals.

32. The method of claim 21, further comprising collecting a fee based on the value of contributed resources.

33. The method of claim 21, further comprising collecting a fee based on rewards to selected solution providers.

34. The method of claim 21, wherein the goal includes a title, a description and one or more goal parameters.

35. The method of claim 21, wherein the resources include one or more of money, facilities, services, and/or other resources.

36. The method of claim 21, wherein the solution proposals include solution proposal parameters, the resources requested to implement the proposal, the timeline for performing the tasks and/or other solution proposal parameters.

37. The method of claim 21, wherein the search is configured to enable search of current and past goals.

38. The method of claim 21, wherein the search is configured to enable search of current and past contributors

39. The method of claim 21, wherein the search is configured to enable search of current and past solution providers

40. The method of claim 21, wherein the search is configured to enable search of current and past solution proposals
